(19) United States
(12) Patent Application Publication
(10) Pub. No.: US 2010/0198420 A1
(43) Pub. Date: Aug. 5, 2010

(54) Dynamic management of power production in a power system subject to weather-related factors

(75) Inventors: Philip Rettger, Moraga, CA (US); Marvin Keshner, Sonora, CA (US); Alexandra Katrina Pligavko, Oakland, CA (US); Jackson Moore, Oakland, CA (US); Bodo W. Littmann, Palo Alto, CA (US)

Correspondence Address: THE NATH LAW GROUP, 112 South West Street, Alexandria, VA, 22314, US

(73) Assignee: OPTISOLAR, INC., Hayward, CA (US)

(21) Appl. No.: 12/320,715

(22) Filed: Feb. 3, 2009

(51) Int. Cl. G06F 1/30; G06F 1/26; G06N 5/02

(52) U.S. Cl. 700/291; 706/46; 700/295

(57) ABSTRACT

Tracking movement of clouds is used to predict the effects of cloud cover on irradiation of a solar-powered distributed power generation system. The predictions enable a solar power plant to maintain the changes in its total power output within operating requirements with less or no dependence on energy storage, back up generation, or load control, use centralized and/or local coordination of solar farm control systems to use storage to its best advantage, alternately reduce power fluctuations without cloud knowledge and use real time solar output prediction capabilities to be able to provide utilities with advance information regarding power fluctuations.

### BACKGROUND

### Field

This disclosure relates to the operation of power systems using solar energy, such as solar farms using photovoltaic or solar-thermal technology, as well as other weather-dependent energy sources. In particular, it concerns applications using measurements to predict meteorological conditions in order to estimate power production and control power generation.

### BACKGROUND

Utilities want and need predictable, stable power generation. End-use devices function best with a steady flow of electricity. The components of the grid system (wires, transformers, etc.) are most reliable when the flow of power is constant, or at least varies slowly and predictably.

Grid operation requires that the supply and demand of electricity be matched at all hours. During normal operation, utilities use power plants in ‘regulation’ mode to match moment-to-moment changes in load and intermittent power production and ‘load following’ to match changes in power as the power demand goes through normal daily load fluctuations. Under contingency operations (for example, when a power plant or transmission line is unexpectedly out-of-service), additional “spinning reserve” and “non-spinning reserve” resources are engaged to maintain grid reliability. Fossil fuel power plants, hydropower plants, power storage facilities, and customer load reductions all provide these services to the grid.

Different power plants have different operating ranges, time response periods and cost-to-respond profiles, and have different roles within grid operations. Some can be started very quickly, such as hydroelectric power plants. Others take longer to ramp up to full production, such as natural-gas-powered turbines. Still others take even longer to increase power production, such as coal-fired plants. If a major power production facility goes off-line or significantly reduces its electricity production, or if load demand increases more significantly than expected, the utilities must respond by starting up an alternative source quickly enough to prevent loss of power for end users.

Intermittent resources significantly impact the electrical grid because fluctuations in power from intermittent resources such as solar and wind occur during normal operation. The utility industry is beginning to deploy large-scale solar farms, producing 10 MW or more power from a single geographic location. Solar power systems produce electrical power as a function of the amount of light, referred to as insolation or irradiance, incident on the component solar panels. The irradiance affects various factors in the generation of electricity from a solar power system. If the solar power system provides a significant fraction of power to a grid operating area or section of the grid, changes in irradiance can have a significant impact on the stability of the power on the grid. The power production from solar farms is very predictable during fair weather because the ramp-up at sunrise and the ramp-down at sunset can be predicted from almanac data, and is suitably gradual that backup sources can be phased in and out at a reasonable rate. Also, on dense overcast days, the power production can drop down to 10% of the clear sky power production, although, the variation in solar production over short durations is not as significant.

Non-grid-connected systems that deliver power directly to end users also need to be stable because electrical equipment can malfunction or even be damaged by a fluctuating supply of power.

Technology exists for tracking major storms, and the corresponding effect on power output from a solar farm in the storm path should be easy to predict; however, the effects of other weather conditions, such as the passage of broken clouds, are presently very difficult to predict or compensate. On partly cloudy days, a solar photovoltaic farm will alternate between full production and 10% power production with ramp times down to seconds or minutes. These ramp times are too short for most common grid backup sources to be brought online from a “cold” start. Alternately, with a smaller control area, there may not be enough regulation or quick changing generation to compensate. Solar thermal systems have an inherent thermal inertia that causes them to react more slowly to irradiance changes than solar photovoltaic systems; however, intermittent shading by patchy clouds can cause unacceptable instabilities in power output for these systems too.

As indicated above, forecasting is used to increase predictability in power fluctuation. Given the forecasts of load demand and intermittent production, the grid operator may start additional power plants and operate the same or other power plants at less than full capacity such that there is sufficient system flexibility to respond to fluctuations. As a result, some grid operators are currently using centralized weather forecasting to predict power output of both wind and solar facilities. In addition, if forecasting information was readily available to operators of non-grid-connected solar and wind systems, the operators could also timely activate backup sources to prevent power interruptions, or reschedule their use of sensitive equipment.

Localized differences in wind speed due to different ground levels or obstructions will affect ambient and solar panel temperature. With changes in temperature, the output power from solar panels will change even if the irradiance does not change. Thus, local landscape features can cause different panels or arrays to produce differing power outputs at any given time.

Even if the terrain is perfectly featureless, as in some plains regions, broken or moving cloud patterns can affect the power outputs and operating factors, such as Maximum Power Point (MPP) of the PV panels below. The more area that a solar farm installation covers, the more opportunities for shifting cloud patterns or fog patches to decrease the power production in a part of a solar farm. Therefore, even with several sensors of sunlight intensity distributed across the area of the solar farm, it is difficult to accurately predict the total power that will be produced by the solar farm in the next few minutes.

A cloud passing over a part of a solar farm can quickly reduce the power generation of that part from maximum to less than 10% of maximum. A transmission grid may be limited in the amount of intermittent power generation that can be interconnected and operated using current technology while maintaining North American Electric Reliability Council (NERC) reliability requirements. Also, in accordance with NERC reliability requirements, each transmission grid operating area (balancing area) is required to identify any power exchange with other balancing areas in advance and then operate their system to strictly adhere to those schedules. Based on the power plants storage and load response available within a balancing area, the transmission grid has a limit to the amount of load fluctuation and intermittency the system can respond to and still meet reliability requirements. Depending on these factors, sometimes a new solar farm with its natural fluctuations can be accommodated with or without forecasting and advanced utility actions. In other cases, due to these factors and other intermittent generation effects, new solar farms' natural fluctuations cannot be accommodated by the existing grid. FIG. 1 is a diagram of a large solar installation with varying conditions for different arrays and groups of arrays within a particular geographical area. Depicted is a varied terrain, symbolically represented by line 111, with a number of solar panels 115 incorporated into a distributed power system. In addition, solar panels provided on buildings 121 can also be incorporated into the distributed power system. As depicted, local conditions may affect irradiation onto the solar panels both in gross and as individual segments. Clouds are significant because they cause substantial variability in the irradiance, including local variations on any solar panels they shade.

Depicted in FIG. 1 are substantially thick clouds 141, thin cloud layers 145, and cloud patterns 149 with convective activity. As indicated by the dotted lines, the clouds create shading patterns consistent with their total density and the solar incidence angle. A thicker cloud layer would cast a darker local shadow than a thin layer, but the overall effect of thicker clouds with smaller horizontal extent may be less significant than that of a thin layer with greater horizontal extent. On the other hand, there are circumstances in which substantial clouds, such as a towering cumulus cloud 149, may have no present effect at all on the photovoltaic network.

Since there is movement of the clouds, it is possible to predict the future positions of these clouds based on their current movement. Thus, if the clouds are moving to the right in the image, corresponding changes in solar irradiation can be expected. Similarly, there are circumstances in which the density of clouds will change over a time period represented by the movement. These changes can be fairly predictable, based on current meteorological conditions and historical meteorological data. Examples of meteorological conditions include effects of wind and wind direction in areas near mountain ridges, stability of the air (a function of the environmental lapse rate), and time of day. Many of these meteorological conditions interact; for example, an upslope wind in warm unstable air in the afternoon is likely to result in rapid cloud formation. As another example, the towering cumulus cloud 149 has no present effect on the photovoltaic network in FIG. 1 because it is not shading any part of the network; however, if the wind blows from the left side of the figure, it will have some effect as it passes, consistent with its size. If atmospheric conditions are sufficiently unstable, e.g., a hot and humid summer afternoon, it can also be predicted that as the cloud passes the affected area, it may develop into thunderstorm activity, with substantially wider coverage.

Utility regulation significantly affects the production of energy from intermittent resources such as solar power. Based on utility and regulatory methods, there may also be some value assigned for how reliably it can provide power when power is needed (capacity value). A dispatchable (controllable) power plant can be under contract to provide both energy and power at the same time. For example, a 100 MW turbine might produce 80 MW of power delivered to the grid to supply energy and then have an additional 20 MW which can be used to provide ancillary services. For example, with frequency regulation, the grid operator sends signals on an ongoing basis, identifying what power level between 80 MW and 100 MW to operate the turbine until the next signal is received. In spinning reserve or non-spinning reserve, the 20 MW is held in reserve and can be provided to the grid on very short notice.

As part of the agreement to connect a power plant to the transmission grid, a power plant may be required to limit changes in the total electricity production at the point of interconnecting to the grid (production ramp). Therefore, a need exists for means of stabilizing the output from intermittent sources such as solar farms.

SENER Ingeniería y Sistemas S.A., of Getxo, Spain, provides a software package called SENSOL that uses historical weather data to predict overall solar farm performance. It does not, however, address the need for solar farms to anticipate and react to rapidly changing conditions in real time. A tool that would perform this function for solar farms and the utilities they serve would be a valuable contribution to the commercialization of large-scale solar power plants at a cost that could effectively compete with less-sustainable power sources.

Sandia National Laboratories has published a program concept on “Solar Energy Grid Integration Systems” (SEGIS). With SEGIS, a utility could connect and disconnect solar sources and storage sources from its grid and control customers' loads according to, among other things, weather “trends and forecasts” from the Internet. This approach has some drawbacks (even supposing that all customers want their power rationed by the utility, in proportions changing daily with the weather, and with less power available in colder weather). The trends and forecasts available on the Internet are typically data reductions geared toward human activities such as travel, recreation, or agriculture. Therefore, those specific weather-related factors that affect power-station output may not be separable from the mix of data. Furthermore, the trends and forecasts tend to be averaged over a large area and a fairly long time (8-24 hours), whereas a power station may be subject to a local microclimate and the fluctuations that most need to be addressed take place on the scale of several minutes.

Planes and boats have on-board weather radar to detect local variations in weather patterns. Also, local weather stations have been deployed for specialized applications such as detecting wind shear and microbursts near airports. These forms of local weather detection have not been applied to use in the prediction of distributed power systems, and have not been used to predict the effects of cloud cover on solar farms or wind farms. More generally, previous systems have not employed local weather detection and local cloud prediction to predict power production dynamics on a moment-by-moment basis.

Solar farms and wind farms have set up local monitoring stations for resource assessment and performance supervision, but this monitoring had not included local weather detection and local cloud prediction to predict power production in real time. This type of real-time data gathering and power prediction would be valuable, especially if linked to a system that enabled corrective action to stabilize farm power output or grid power in the event of an unacceptable degree of expected fluctuation.

### SUMMARY

Control is implemented in a power generation system and/or storage system associated with the power generation system, in which the power generation system generates power from least one weather-sensitive power source (that is, a source having a power output that may be affected by weather-related conditions). Information on weather-related factors that can affect the power output of the power generating system is obtained from measurements, from external sources, from stored data, or from a combination thereof. From this information, the control system calculates at least one of the amplitude, rate of change, onset, and duration of an expected change in power output from the power generating system. The control system compares the calculated expectations with predetermined thresholds representing acceptable changes in power output. Based on the results of the comparison, the control system selects and executes a response. For example, if the expected power-output change does not exceed any of the predetermined thresholds, the control system continues monitoring weather-related factors. It should be noted that, if the calculated expectations exceed a predetermined threshold, the control system may adjust the power output from the power generating system so that the actual output changes do not exceed the predetermined threshold.

### BRIEF DESCRIPTION OF THE DRAWINGS

FIG. 1 is a diagram of a large solar installation with varying conditions for different arrays and groups of arrays within a particular geographical area.

FIG. 2 is a graph showing examples of solar farm power output variations in a 24 hour period under different weather conditions.

FIG. 3 is a flow diagram showing operation of an example cloud tracking system.

FIG. 4 is a flow diagram showing an overview of the basic process of receiving and evaluating measurements.

FIG. 5 is a flow diagram showing an example process of receiving and evaluating measurements.

FIG. 6 is a flow diagram showing an enhancement of the process of FIG. 5, in which historically-based correction factors are used.

FIG. 7 is a flow diagram depicting reaction steps implemented as grid notification.

FIG. 8 is a flow diagram depicting reaction steps for controlling ramp-down rate in response to a prediction of reduction in output resulting from cloud passage.

FIG. 9 is a flow diagram depicting reaction steps for ramp-rate control.

FIG. 10 is a flow diagram depicting reaction steps for energy storage, which is similar to the reaction steps for ramp-rate control depicted in FIG. 9.

FIG. 11 is a flow diagram depicting a configuration in which sensed power is used to control ramp rate.

### DETAILED DESCRIPTION

### Overview

As described herein, “solar farm” is intended to include a variety of configurations of a power generating station, including arrangements of photovoltaic, wind, or solar-thermal generators on open land, on diverse structures, such as buildings, other types of solar collectors, and combinations of these.

Atmospheric-condition tracking for predicting short term effects of clouds and other weather-related factors on a power station or other defined area includes a number of features relevant to observations:
1. improved data gathering to sense approaching changes in ambient conditions that affect power station output;
2. interpreting the data to predict the actual effect on power station output; and
3. responses to the interpretation aimed at reducing the resulting fluctuations in available power from the power station available to the power grid to maximum allowed fluctuation levels or to shape the power to a specific load shape. These responses include, but are not limited to,
   a. preemptively reducing station output to reduce the rate of change, using stored energy to reduce the rate of change,
   b. using external sources of energy or load reduction to reduce the combined rate of change on the system, or
   c. notifying the utility of the upcoming fluctuation, so that they can increase the flexibility of their system.

Direct sensing of output power fluctuations in localized parts of a geographically extended power system (for instance, fluctuations in the output power of individual panels, sub-arrays or arrays) is another source of data that can be used to predict what will occur in other parts of the system. For instance, when clouds pass over an array, they cause output power fluctuations as they shade each panel. If the power delivered by individual panels or sub-arrays at known locations is tracked over time, the speed and direction of the transient shading fluctuations can be calculated. Once the speed and direction is known, further calculations can predict which other arrays will be similarly affected, and how soon.

Weather-Related Variations in Power Station Output

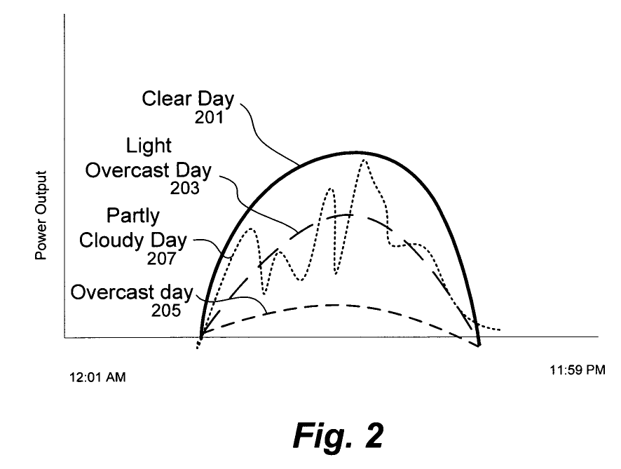

FIG. 2 is a graphic depiction showing examples of solar farm power output variations in a 24 hour period under different weather conditions. On a clear day, irradiance tends to be consistent and predictable, as indicated by curve 201. On a day with overcast, but with constant cloud thickness, a similar predictable irradiance profile occurs, as indicated by curves 203 and 205. In the example, curve 203 represents a light overcast condition, with curve 205 representing a heavier overcast condition. On a partly cloudy day, the irradiance would vary in accordance with cloud formations passing the affected area, as indicated by curve 207. In such cases (partly cloudy days), it becomes advantageous to predict localized cloud changes because the output of a solar farm might otherwise change more rapidly than purely reactive backup systems could compensate.

Calculations of Impact of Conditions

Calculations or impact of conditions used to predict localized irradiance changes due to cloud passage may also take into account almanac information relating to location, time of day and time of year. From the almanac information, the position and angle of the sun with respect to the solar panels during the passage of the clouds may be calculated. In addition, a prediction of cloud coverage and cloud movement augments the predicted irradiation by way of calculations of an expected amplitude, onset, rate of change, or duration of reduced power generation due to effects of atmospheric conditions, or any combination thereof. The effects of atmospheric conditions include shading by clouds and increased power generation due to dissipation of clouds. Calculation of the effects may include calculation of one or more of:
changes in solar brightness on the panels based on location, time of day, and time of year,
changes in relative strengths of the direct and diffuse irradiance components,
changes in the spectral content of the sunlight on solar panels within the distributed power system after passing through the clouds, and
changes in ambient temperature, which affect array efficiency and maximum power point (MPP) of the photovoltaic panels within the photovoltaic arrays.
changes in atmospheric temperature gradients and atmospheric pressure gradients in the vicinity of the power generating system that may affect approaching clouds and wind.

Clouding can also change the ambient temperature around solar panels, which can affect their efficiency and their maximum power operating point (MPP). In addition to the direct effects on photovoltaic solar cell performance, the effects of clouding can be used as a predictor for further clouding. By way of example, temperature change prediction can add another level of accuracy to the power prediction.

External Sources of Weather-Related Information

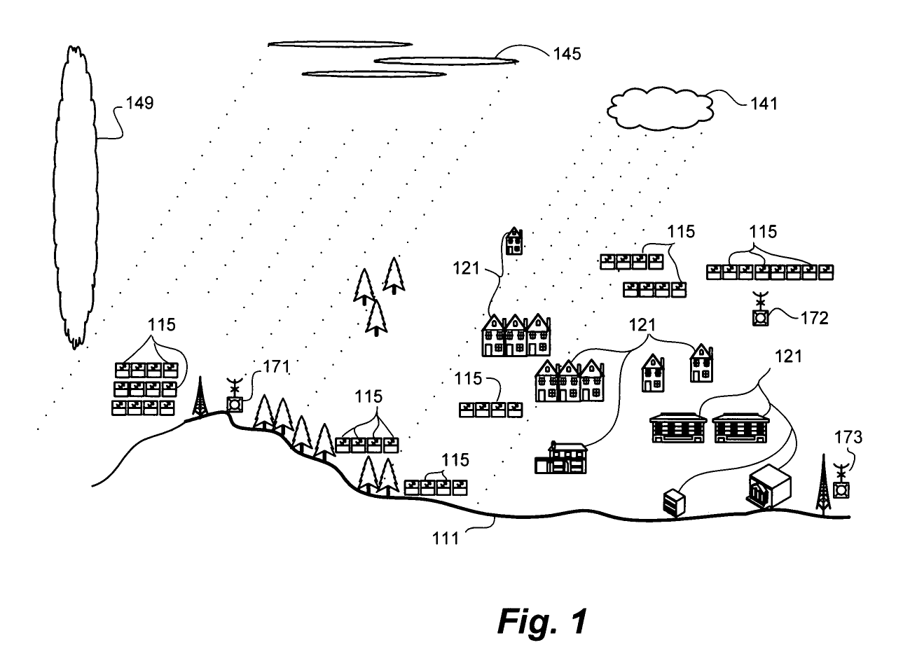

In one configuration, local cloud conditions are tracked by one or more weather tracking stations, such as weather tracking stations 171, 172, 173 depicted in FIG. 1. Cloud conditions include cloud formation, cloud position (height and horizontal location), movement (speed and direction), cloud density and cloud type. Weather tracking stations 171-173 gather information on cloud conditions that include the height of the bottoms and tops of clouds, the distance and compass bearing of clouds, the speed and direction of motion of the clouds, the density of the clouds, whether the clouds are expanding in volume or contracting, the types of clouds (cumulus, cirrus, etc.) and other aspects. Other meteorological data is obtained from the weather tracking stations 171-173 or from external regional sources.

Atmospheric-condition tracking includes a combination of external report inputs, a modification of the reports in accordance with local conditions, and inputs from measured observations. Measured observations may be obtained directly from the output of a solar system or from external automated weather stations, typically provided by third party sources. Examples of external automated weather stations include Automated Weather Observing System (AWOS), Automated Surface Observing System (ASOS), and Automated Weather Sensor System (AWSS). Other external sources of weather information are widely available forecasts and measurements of meteorological data, including ultraviolet (UV) forecasts, external UV measurements, external insolation measurements, temperature/dew point spread, regional wind measurements, stability of the air (environmental lapse rate), nearby solar farm measurements and private weather station data. Externally obtained weather data which could come from a third party or from the solar farm operator controlled off-site monitoring station could also include regional wind measurements, visibility and obscurations, precipitation, cloud cover and ceiling, and temperature/dew point information. While most of these measurements can be used to predict cloud cover, the cloud cover and ceiling information is particularly useful because of the direct effect of clouds on irradiation.

Cloud cover and ceiling measurements can be made with a ceilometer. This instrument is one application of a LIDAR (Light Detection and Ranging) system, where the laser beam is pointed upward at the zenith and detects the amount and height of clouds. In addition, non-LIDAR ceilometer instruments such as optical drum ceilometers can be used to obtain this information. In a typical weather observation station, cloud density measurements are obtained by calculating an average or a weighted average of readings over time. One aspect of ceilometer measurements is that the ceilometer is able to (as the name suggests) take ceiling measurements, meaning the bottoms of cloud layers, but is less adept at determining densities of cloud layers. In its raw form, a ceilometer measurement provides no indication of cloud tops, thicknesses or densities, except in cases where thin layers create ambiguities in the actual measurements. The different types of responses obtained from LIDAR or ceilometer measurements and from radar measurements can be used to provide further information regarding cloud density and other cloud conditions.

In addition to vertical measurements, it is possible to obtain measurements at multiple angles. A more general scanning LIDAR can provide three-dimensional images within a cone of the sky, and a doppler LIDAR can measure cloud movements. The use of angled measurements, in combination with wind measurements, makes it possible to obtain information regarding the change of cloud coverage. It is possible to measure the movement of the edges of the clouds, which provides an indication of cloud movement, and this can be accomplished with vertical and/or angular measurements. In addition to observed changes in cloud movement, it is possible to use surface wind measurements, with an appropriate correction counterclockwise from the surface (northern hemisphere), to predict winds aloft.

Similar weather monitoring techniques can be used for other types of power systems that are weather-dependent. By operating (or connecting to) sources of data on selected relevant weather-related variables, those specific weather factors that affect power-station output can be isolated to streamline the analysis.

Measurement of Conditions

On-site forecasting may be achieved either from a single location or from multiple locations with distributed weather sensors, such as a network of monitoring systems throughout the solar farm site, around the periphery of the solar farm site or from off-site locations near the power generating system. It is also possible to provide weather sensors at off-site locations a significant distance away from the power generating system. Distributed sensors, including on-site sensors, can be more effective than central forecasting for predicting a solar farm's power production relative to the grid operator's forecasts because they can provide multiple checkpoints to take account of the effects of local terrain, local wind conditions, observed convective activity, etc. “Distributed sensors” can refer to any group of sensors at more than one location. The distributed sensors may be at various locations within the general perimeter of the solar farm, or can be off-site, provided that the sensor data is relevant to cloud prediction. This is advantageous in locations where multiple geographical features that interrupt wind currents or change the humidity content, such as mountains, rivers, bays, lakes, and volcanic-type features such as hot springs, create varied local microclimates. In such areas, cloud patterns can change significantly in the course of crossing from one microclimate to another.

Localized sensing can include sensing of local irradiance (e.g. using pyranometers), or sensing of the power output of reference photovoltaic cells as changes in ambient conditions affect them, as well as sensing atmospheric conditions with instruments such as radar, LIDAR, visual sensors such as cameras, and thermal sensors. The locally sensed data may be combined with data from other sources, such as ground and satellite-based weather stations.

Radar sensing allows detection of visible meteorological conditions. The solar farm may be provided with a small weather radar station, similar to those used on ships. With clouds typically at an elevation of 1500 meters, the weather station would be able to detect the presence of clouds for a 140 km radius around the local station associated with a solar farm. The radar may be capable of detecting the location of the clouds, their speed, and the direction of their movement. A simple computer program combining the radar data with the sun's calculated position (based on the date, the time, and the farm's location) could predict the upcoming shading of the solar farm and project the power production vs. time, and provide projections out into the future. The predictions would be directed to both the change in power production and the rate of change.

LIDAR sensing is best for identifying aerosols and visible clouds. Radar is better than LIDAR for identifying precipitation and, depending on the power and topography, may have a greater range. LIDAR is similar to radar, in that it computes the distance to the target by emitting electromagnetic pulses or continuous waveforms and measuring the time delay between the transmission and arrival of the reflected signal. In contrast with radar, the wavelength of the light emitted by the LIDAR system's laser is on the same order of the cloud particle diameters that scatter sunlight as described by the Mie theory (or Mie solution to Mie scattering). Thus clouds are very opaque to LIDAR, and provide a good back-scattered signal. This is in contrast to the much longer-wavelength radar which is good at detecting metallic objects and relatively large precipitating water droplets; however, clouds themselves are relatively transparent targets. Also, the laser's extremely narrow beam and low divergence affords superior spatial resolution not achievable with radar. Radar, on the other hand, can provide additional information relating to cloud density or thickness.

Cameras or other visual sensors can provide additional detail for forecasting changes in power output on the scale of minutes. For example, they can be used to distinguish thin from thick clouds and also to measure the spectrum of the light. Similar computer programs would be used to interpret the data received from the cameras and other visual sensors. This can be accomplished, for example, by densitometry measurements of digital images of clouds; the densitometry values are indicative of relative cloud opacity. Additionally, frame-to-frame motion and shape changes can be tracked to obtain speed, direction, and probability of convective action. Pattern recognition programs can be used to distinguish between cloud types, e.g., cirrus from cumulonimbus. A more complex program can combine locally gathered data with data from other sources to predict more than the change in brightness of the incoming sunlight. By way of non-limiting example, changes in the relative strength of the direct and diffuse components of sunlight, and changes in the spectral profile—both of which affect solar cell efficiency and hence solar farm output—can be tracked.

Clouds can also be detected and tracked by monitoring the actual power output of parts of the solar farm. When a cloud edge passes over a solar panel, the power output from that panel or string of panels will change. By measuring the output of the photovoltaic panels, a direct reading of irradiation is obtained. The movement of cloud cover is detected as the power output of sequential panels changes. When the power from one panel, sub-array, or array changes, that information can alert a human operator or automated control system that the power from other panels, sub-arrays, or arrays are about to experience similar changes. By consulting a look-up table of affected panels' geographical location, the speed and direction of the power changes can be mapped, and their future trajectory and arrival time at other locations predicted. Similarly, if two or more solar farms share the data, a farm that is presently undergoing power changes can alert another farm if the changes are moving in its direction so that the other farm can prepare to react to the changes.

Historical Information

Local regions, including the locations of power stations, sometimes have special characteristics that affect incoming changes in cloud cover and other weather-related effects. Because these special characteristics are largely related to geographic features such as land contours, bodies of water, and geothermal zones, in most cases their effects on incoming weather patterns are repeatable, or at least capable of being extrapolated from previous trends. Enhanced embodiments of the present subject matter take advantage of stored historical data related to special characteristics of the power station's location to enhance the accuracy of predictions. Almanacs provide historical data on an area's high, low, and average temperatures as well as other statistics. These statistics can be factored in to calculate the likelihood that a predicted change in atmospheric conditions is accurate.

Advanced embodiments of the present subject matter can “learn” from the data they have gathered in the past. Both predictions and actual results can be stored in archives, and correction factors to enhance the accuracy of future predictions can be calculated and updated. For example referring to FIG. 1, suppose a group of medium-opacity cumulus clouds is detected by sensor 172, approaching the power station from the west at 30 km/h. A straightforward calculation based on current speed and direction might predict that they would begin producing a 2% shading in 30 minutes, which would end in 60 minutes. However, if the system has stored records indicating that clouds are typically delayed and thinned by an escarpment lying between the first sensor 172 and the power station, and statistics on typical degrees of delaying and thinning, it might correct the prediction to a 1.5% shading beginning in 45 minutes and ending at 75 minutes after comparing the present calculation to the stored records and deriving and applying correction factors based on the comparison. This enhancement of accuracy accounting for local factors makes operation more economical; for instance, by only reducing power output by the amount and for the duration that is absolutely necessary. Alternatively, embodiments that calculate less than all four of the onset, amplitude, rate of change, and duration of an expected change may take advantage of historical data to extrapolate expected values of the other quantities based on past experience.

Predicting the Impact of Conditions on Power Station Output

With the various measurements of the local weather, the power output of a solar farm or a local collection of solar panels mounted on rooftops, in parking lots or on the ground can be predicted. For example, the weather radar can track the movements of distant clouds that may be approaching the local region and measure their speed and direction. Given the current speed, direction and distance, and knowing the position of the sun versus time of day, a computer program can calculate when the clouds will shade the solar panels. The weather radar can also estimate the density of the clouds and how much they will reduce the solar irradiance on the panels. As the leading edge of the cloud shadow moves onto one or more solar panels, it will decrease the power output from that solar panel; the decrease in power provides a direct measurement of the reduction in irradiance caused by the cloud's arrival.

Clouds can shade solar panels by moving across the sky to a location where their shadows fall upon the solar panels. However, clouds can also form directly above the solar panels from a previously clear sky. As they form, they might or might not also move. By adding data from external weather forecasts to the predictive calculations, the program(s) can predict whether the clouds are likely to increase or decrease in size, density or other properties that affect their shading properties as they form or move. For example, by combining a national weather-service prediction of summer afternoon thundershowers and local observation of new clouds forming, the program(s) could more accurately predict whether and when the cloud cover is likely to affect solar power production and by how much.

Typically, clouds move at a speed of less than 70 km/h. Therefore, with cloud tracking radar with a range of 140 km, in typical situations, the computer program would be able to predict power production for the next two hours. On a very, very windy day, with steady winds aloft of 140 km/h (equivalent to a Category 1 hurricane), it would still be possible to predict 1 hour into the future, which indicates that predictions are likely to exceed 1 hour in any weather conditions in which predictions would have value. Therefore, the solar farm or utility would have at least 1 hour, and often have 2 hours or more, of notice to prepare an alternative power generation source.

The output of the solar panels decreases with increasing temperature of the solar panel. The temperature of the solar panel is determined by the ambient temperature, the intensity of the sunlight hitting the solar panel and the amount of cooling of the solar panel by wind. More irradiance would generally result in more power output; however, if the increased irradiance heats the panel significantly, the power increase may be attenuated. For a given type of solar panel and a given mounting angle, its temperature can be determined experimentally as a function of ambient temperature, wind speed, wind incidence angle and sunlight intensity and then stored in a database in a computer system. Then, by measuring the local wind speed, the local wind direction, and the local intensity of sunlight affecting an installed group of solar panels, the computer can calculate the likely temperature of the solar panels from the stored information in its database and predict the likely level of the panels' power output. The accuracy of the prediction can be improved with the use of historical information and by comparing predicted to actual results from other solar farms.

Responding to Predictions of Power Output Changes

A control system for the power generating system is able to respond to predicted changes in power output that exceed threshold criteria imposed by the grid or load to which the solar farm supplies energy. Predetermined threshold criteria for acceptable amplitudes and rates of change (“ramping rates”) can be stored in the control system. These criteria can be based on customer specifications, limitations of the connected grid, production targets of scheduled power and intermittent energy, regulatory requirements, or power connectivity standards promulgated by organizations such as IEEE. They can also vary with measured or expected demand for the time of year and time of day of the expected onset and duration of the change; for example, a grid may be able to tolerate a larger amplitude of power decrease from the power generating station during non-peak demand hours than during peak demand hours.

Each calculation of an expected change can be compared to the relevant threshold criteria to produce a comparison result. If the comparison result does not exceed the threshold criteria, the power station can continue to monitor weather-related factors and take no further action. If the comparison result exceeds the threshold criteria, the power station can select and execute an appropriate response based on the characteristics of the comparison result.

The power generating system's operator (human or machine) may take various steps to mitigate the total fluctuation seen by the grid operator. This could include 1) proactively reducing power output at an acceptable rate before a downward trend begins, 2) controlling the upward ramp rate of power output, by limiting change of power when an upward trend begins, 3) using stored energy to limit the rate of increases or decreases in power output, 4) using backup generation resources which could produce energy to reduce the combined rate of change to target levels, 5) reducing the demand of a large energy consumer within the transmission and distribution area, to reduce the combined rate of change to target levels, and/or 6) communicating anticipated changes to a power utility or grid operator. In the case of energy storage facilities, in instances where wide fluctuations are expected during a particular time period, energy storage can be particularly useful because this allows the distributed power network to be operated at near maximum available power at any given time while providing a less dynamic or more stable output to the power grid. Actively managing the power could have various goals including: 1) reducing the change in power to within contracted or acceptable limits, 2) matching a contracted output profile, which could be in various increments including 10 minute, 15 minute, or 60 minute increments, or 3) matching a non-contracted pre-promised profile.

Control of Production from Solar Output

Proactively reducing the power output from the solar facility is implemented to prevent the facility from exceeding the grid's production ramp-rate requirements as clouds cover the facility. For example, in a photovoltaic farm, a control system that controls the inverters via a network can issue commands responsive to the gathered data. If a power plant has many inverters, the ramp rate of each inverter could be limited, or selected inverters could cease to deliver power (by being turned off, disconnected, or having their power diverted to storage or other backup sources) in stages while others continue to operate at maximum available power output. For the second case, the total power sent to the grid could be gradually ramped in either direction by sequentially switching inverters on or off. Those skilled in the art will recognize that “turning an inverter on or off” embraces other modes of activation and deactivation, such as exiting or entering a standby mode. It could also be the case that one inverter is dropping power while another inverter is increasing in power. In this case a central control system could monitor all inverters to maximize the total energy produced while still meeting maximum farm level ramp rates.

For a large farm with many inverters, a suitably gradual ramp may be achievable by selectively turning inverters on or off rather than operating them over a range of intermediate power levels to achieve a ramp in power level. Turning inverters on and off results in a ramp with “steps,” rather than a smoothly varying ramp, in the total output power from the farm. If the farm has many inverters, the step height from turning any single inverter on or off will be only a small fraction of the total output power, so the non-smoothness of the ramp may be insignificant to grid stability. On the other hand, a farm with fewer inverters operating at higher power may produce a ramp with unacceptably large steps by turning inverters on and off. In that situation, the control system could change the operating point of one or more selected inverters (toward or away from the MPP) to produce the desired power level and ramp rate. Other factors to be considered when choosing between the “on/off” and “intermediate power level” embodiments are the optimum operating ranges of the inverters and the capabilities of the inverter control system.

Control of the upward ramp rate of power output as clear sections of sky replace the clouds over the solar facility is implemented because power grids do not perform well when the output of a power source changes rapidly in either direction. Possible approaches for controlling the upward rate of power output whenever an unacceptably steep upward trend begins are:
1) programming each inverter to limit the upramp in that inverter's power output in all instances, i.e., control of inverters individually by processors resident in the inverters;
2) using a central control system to sense upward power ramps and coordinate inverters to ensure that the upward ramp is within acceptable limits;
3) gradually causing selected inverters, previously commanded to cease delivering power, to resume delivering power based on a schedule that provides an acceptable ramp rate of power from the entire plant; and
4) using sensed atmospheric data to anticipate the departure of clouds, predict the resulting increase in irradiation over the solar facility, calculate the output power ramp that the predicted increase in irradiation is likely to produce, determine whether the calculated ramp is unacceptably steep, and, if so, actively control the farm level output to produce an acceptable ramp rate.

The control of inverters in the departure of clouds and increase in power can be done in manners similar to the control of inverters in the anticipation of the arrival of clouds and reduction in power. In this case, a central control system, such as a Supervisory Control And Data Acquisition (SCADA) system, could achieve the ramp at the farm level either by turning inverters from off to on or from on to off or by operating inverters at less than their maximum available power output.

Alternatively, in a system with “smart” inverters, whether or not a control system is included in the inverter network, each inverter could be programmed to ensure that it does exceed certain power ramp requirements. If the DC input power entering the inverter begins increasing at too fast a rate, the inverter can operate off the maximum power point (MPP), for example by increasing voltage and decreasing current, thereby reducing its immediate AC power output to the grid. As the incoming DC power level stabilizes, the inverter can gradually return to MPP operation and optimum efficiency at a grid-compatible ramp rate.

Deploying Backup Power Sources to Compensate for Weather-Induced Power Fluctuations

Onsite or remote power storage may be used to mitigate fluctuations in power output to meet production ramp interconnection requirements. One version of this strategy uses centrally controlled, physically distributed storage. Each array routinely stores power in a battery, flywheel, or other energy storage system. The control system is able to monitor and optimally utilize the stored power in all the energy storage systems, as well as monitoring the solar farm output, from a single control point. Such a system may use sensors and algorithms in order to smooth out rapid fluctuations from cloud passage. The system may also be configured to connect the storage systems to the control system through the network used to control the inverters.

Alternate Generation

There may be entities within the transmission and distribution grid area that have backup generation capacity. If these entities produced energy as the output from the solar farm declined, the combined rate of change of the solar farm and the backup generation could be within target levels.

Control of Load Demand

There may be large energy consumers within the transmission and distribution grid area that could reduce their demand for power as the output from the solar farm declines. The combined rate of change of the solar farm and the large energy consumer could then be kept within target levels. In this manner, communication with users may include communicating with a non-utility partner who would then be able to adjust generation or load demand on the grid.

When the power ramps upward, as when clouds over a solar farm dissipate, some loads could be increased to slow the increase in supply to the grid. For instance, a greater fraction of produced power could be diverted to storage when the upward ramp is too steep.

Notifying Operators of Upcoming Power Fluctuations

Sending communications that notify a utility or grid system operator of upcoming output fluctuations from a solar farm or other power station allows the utility or grid operator to operate flexibly to mitigate the effects of the expected fluctuations on grid stability. This could be achieved by multiple methods including:
1) increasing the number of power plants online and running the power plants at less than full power in order to increase the amount of available upward frequency regulation,
2) increasing the amount of power imported from other control areas and running the in control area power plants at less than full power in order to increase the amount of available upward frequency regulation, or
3) readying large energy consumers to reduce demand.

This communication function could also be used for sharing data between the solar farm and the utility, grid system operator, other solar or wind farms, or other local weather monitoring stations. A central control system could gather data for, and react on behalf of, multiple farms spread across a geographic area similarly affected by weather patterns.

Combined Controls

A combination of solar forecasting, inverter controls, storage or other responses, may be used. The computer program would be used to regulate the power to a certain level using a combination of the various techniques above.

Prediction-Enhanced Supply Flexibility from Weather-Affected Power Stations

Solar and other intermittent resources currently sell energy. As part of a power purchase agreement, any capacity or power value may be sold together with the energy. By combining storage and power control algorithms in a solar power plant, such a plant could function as both intermittent (non-dispatchable) and a dispatchable resource. Software is able to track the energy from the intermittent solar facility separately from the power or regulation services provided by the storage facility. Thus, the operator of a solar farm is able to conveniently sell both the intermittent energy (with its associated capacity value) and the dispatchable regulated power through the same interconnection point. The control system (with or without storage) could also provide ancillary services to the grid, including but not limited to voltage regulation, frequency regulation, power factor correction, load following, and spinning and non-spinning reserve.

Further Description of Diagrams

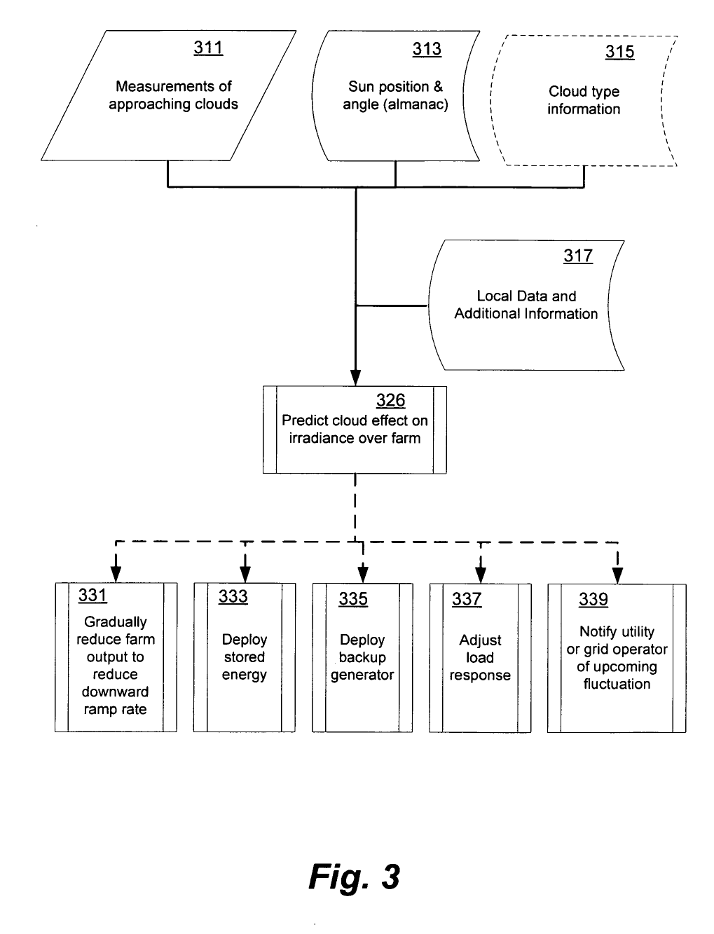

FIG. 3 is a flow diagram showing operation of an example cloud tracking system. The system has inputs relating to measurements of approaching clouds 311, almanac data related to sun position for the particular date and time at the solar farm location, indicated at 313, and information regarding the optical transmittance of different types of clouds, indicated at 315. The optical transmittance of different types of clouds includes information as to how the clouds affect diffuseness (by scattering), spectral content and related properties of sunlight. These factors are adjusted for the particular sensing mechanisms used to detect clouds, since different sensing instruments obtain different types of information regarding clouds. Additional factors 317 include local conditions which affect cloud movement and irradiation. An example of a local condition would be nearby mountain ridges.

The input information is used to predict cloud effects on irradiation, as indicated at block 326.

The output of the prediction (block 326) may be used for several types of response, depending on the particular configuration of the system. Examples of responses include reducing solar farm output to smooth output fluctuations (block 331), using stored energy (block 333), alternate generation from backup sources (block 335), adjust load response to compensate for output fluctuations (block 337) and notification of the utility or grid of an anticipated fluctuation (block 339).

Operation

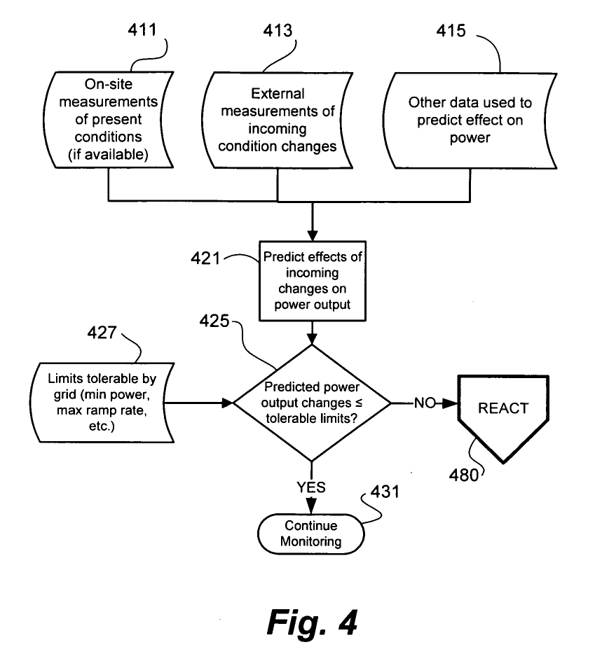

FIG. 4 is a flow diagram showing an overview of the basic process of receiving and evaluating measurements. Depicted are predictive factors including on-site measurements of present conditions 411, if available, external measurements of incoming condition changes 413 and other data 415 used to analyze the data and thereby predict effects on power. This data and received measurements 411-415 are predictive factors. The other data 415 used to predict effects on power include almanac data, such as data used to determine sun position and historical data. The predictive data 411-415 is used to predict effects of incoming changes on power output (step 421). A determination (step 425) is made whether the predicted output changes are less than tolerable limits, which are determined by tolerable limit settings 427, which may be static or dynamic data. In the case of the changes being within tolerable limits, the system continues monitoring (step 431); otherwise, the system issues a “REACT” decision or command (step 480). The “REACT” decision (step 480) provides an indication for the system or an external system on the grid to respond to the predicted output change.

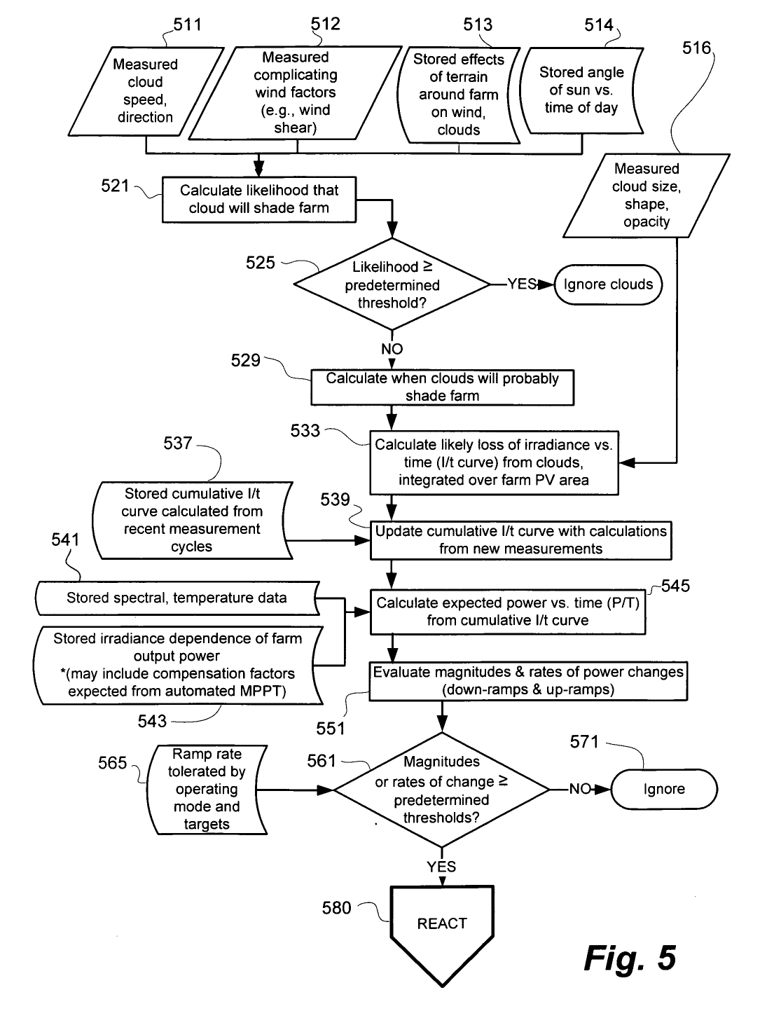

FIG. 5 is a flow diagram showing an example process of receiving and evaluating measurements. The received measurements depicted include predictive factors, including obtaining measured cloud speed and direction (step 511), obtaining measured complicating wind factors (step 512), such as wind shear, convective activity, and wind veer, obtaining stored effects of local terrain on wind and cloud development (step 513) and obtaining stored solar position and angle based on time of day and calendar day (step 514). (Wind veer represents a change in wind direction at altitudes above surface altitude. Typically wind turns clockwise with altitude from the surface due to the Coriolis effect, but this can predictably vary in response to meteorological conditions, with reverse wind veer or “backing wind” possible.) Also obtained are evaluation factors, such as measurements of cloud size, shape and opacity (step 516).

The prediction factors obtained at steps 511-514 are used to calculate a likelihood that clouds will shade portions of the farm (step 521). A determination (step 525) is made as to the likelihood of cloud cover being less than a predetermined threshold. In the case a negative determination (at 525), i.e., cloud cover exceeds a predetermined threshold, a calculation is made (step 529) as to when the clouds will probably shade the farm.

This calculation (step 529) is used to calculate (step 533) loss of irradiance vs. time from clouds, integrated over the farm area, using the measurement of cloud size, shape and opacity (step 516). The calculation is:

I/t integrated over Areapv

where

I=irradiance

t=time and

Area_{PV}=farm area.

Upon obtaining the loss of irradiance vs. time (step 533), a stored cumulative I/t curve for previously measured clouds is retrieved (step 537). The current I/t curve is added to the historical one by updating the cumulative I/t curve with calculations from the new measurements (step 539). The updating (step 539) is used to extrapolate the irradiance trend into the future. Stored spectral and temperature data and stored irradiance dependence of farm output power are provided (steps 541, 543) and the stored data is used to calculate expected power vs. time (step 545) from the cumulative I/t curve retrieved in steps 537 and 539. An evaluation of magnitudes & rates of power changes (step 551), such as down-ramps and up-ramps, is made. A determination (step 561) is then made of whether the rates of change exceed predetermined thresholds, using evaluation 551 and a value for ramp rate 565 tolerated by the grid.

Determination 561 is used to determine whether to ignore the anticipated change (step 571) or issue a “REACT” decision 580 which can be used for notification, ramp-rate-control, storage, back up generation or load response/reduction in demand.

Reacting to Predicted Changes

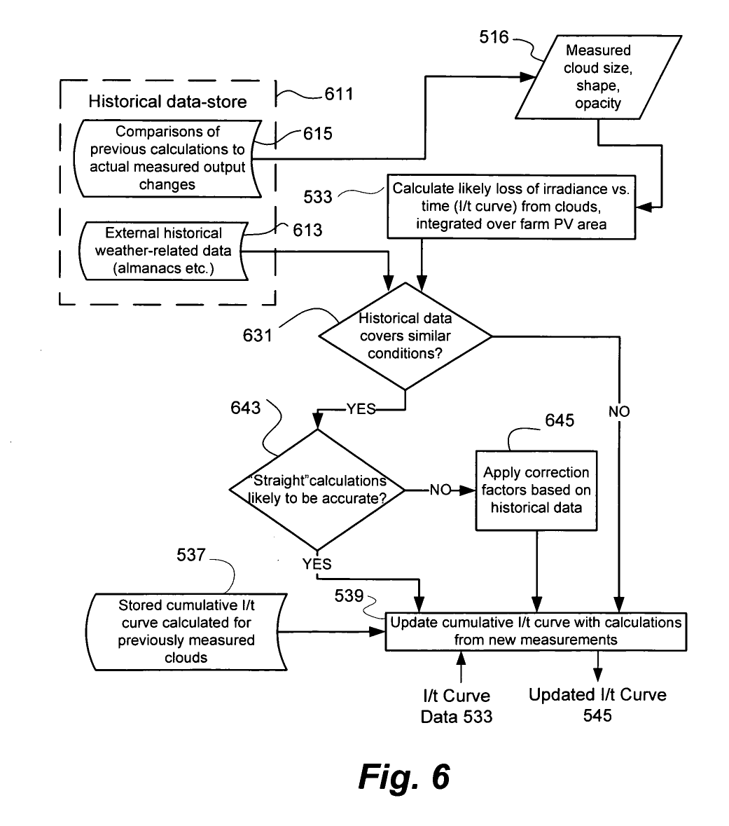

FIG. 6 is a flow diagram showing an enhancement of the process of FIG. 5, in which historically-based correction factors are used. An historical data store 611 includes external historical weather-related data 613, such as almanac data, and comparisons of previous calculations to actual measured output changes 615. Comparisons 615 are incorporated into the measured cloud size, shape and opacity (measurement 516). The external historical weather-related data 613 is combined with the calculated loss of irradiance vs. time from clouds (step 533) and a determination (step 631) is made as to whether the historical data covers similar conditions to the calculated loss of irradiance vs. time from clouds (step 533). In the case of a negative determination (step 631), the current I/t curve is updated with calculations from the new measurements (step 539). In the case of a positive determination (step 631), a determination (step 643) is made as to whether calculations based on newly-acquired data is likely to be accurate.

If the calculations based on newly-acquired data is not likely to be accurate (step 643), historical data is used to apply correction factors (step 645) and the historical data is used to update the cumulative I/t curve with calculations from the new measurements (step 539). In the case of a determination (step 643) that calculations based on newly-acquired data is likely to be accurate, the new data is provided for the purpose of updating the cumulative I/t curve with calculations from the new measurements (step 539).

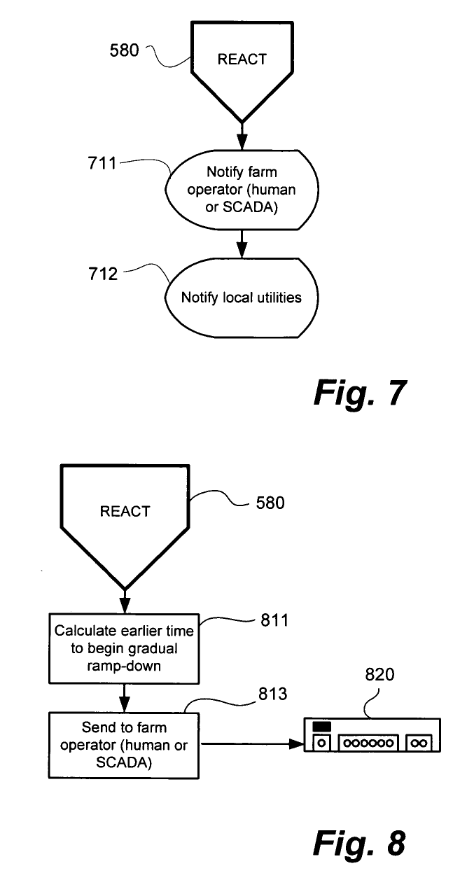

FIG. 7 is a flow diagram depicting reaction steps implemented as grid notification. Upon receipt of “REACT” decision 480 or 580, a farm operator is notified (step 711) and the farm operator notifies local utilities on the grid (step 713). The farm operator may be human, or alternatively, the farm operator may be a Supervisory Control And Data Acquisition (SCADA) module.

FIG. 8 is a flow diagram depicting reaction steps for controlling ramp-down rate in response to a prediction of reduction in output resulting from cloud passage. In this procedure, a slower ramp-down rate is achieved by predicting the power loss. After receiving REACT decision 580, a calculation is made of an earlier time to begin a ramp-down of power output (step 811). The earlier time permits power output to be reduced more gradually than would occur if the system awaited loss of power from cloud shading. A signal is sent to the operator (step 813), and the operator is able to use the information to initiate the reduction in power output. The operator may be human or may be a Supervisory Control And Data Acquisition (SCADA) system 820 or other computerized system.

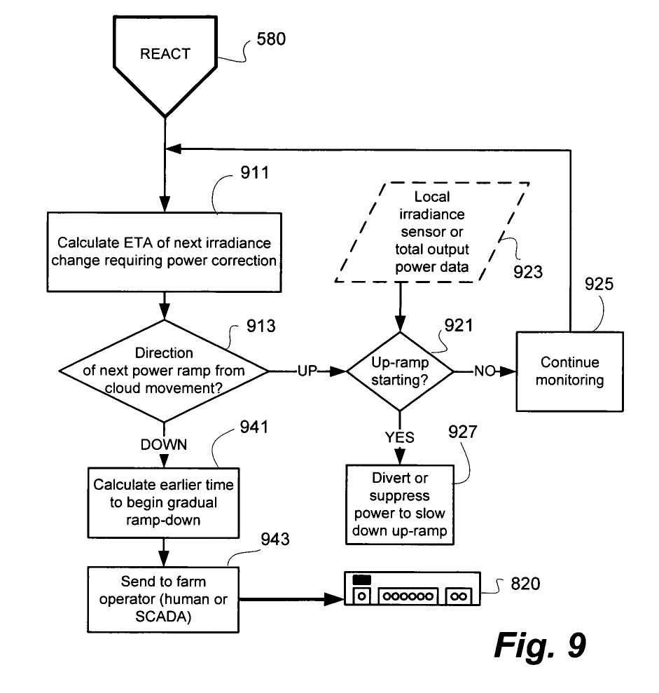

FIG. 9 is a flow diagram depicting reaction steps for ramp-rate control. Upon receipt of “REACT” decision 480 or 580, a calculation of an estimated time of arrival of the next irradiance change requiring power correction is made (step 911). A determination (step 913) is made of the next power ramp from cloud movement. In the case of an up power ramp determination (at determination step 913), a determination 921 of up ramp starting is made based on receipt of local irradiance sensor data or measured power output (step 923). The measured power output (step 923) can be the total power output of the farm, a portion of the total output, or may be from one or more sensors.

The determination is continued (step 925) until an increase in local sensor data, in which power is diverted or suppressed (step 927) to slow down the up-ramping. The slowing (step 927) may be accomplished by a number of techniques, including intentionally operating off Maximum Power Point (MPP).

In the case of a down power ramp determination (at determination step 913), a calculation (step 941) is made of an earlier time to begin a gradual ramp-down. The calculation is sent (step 943) to the farm operator. The farm operator may be human, or alternatively, the farm operator may be a SCADA module 820 or other computerized system.

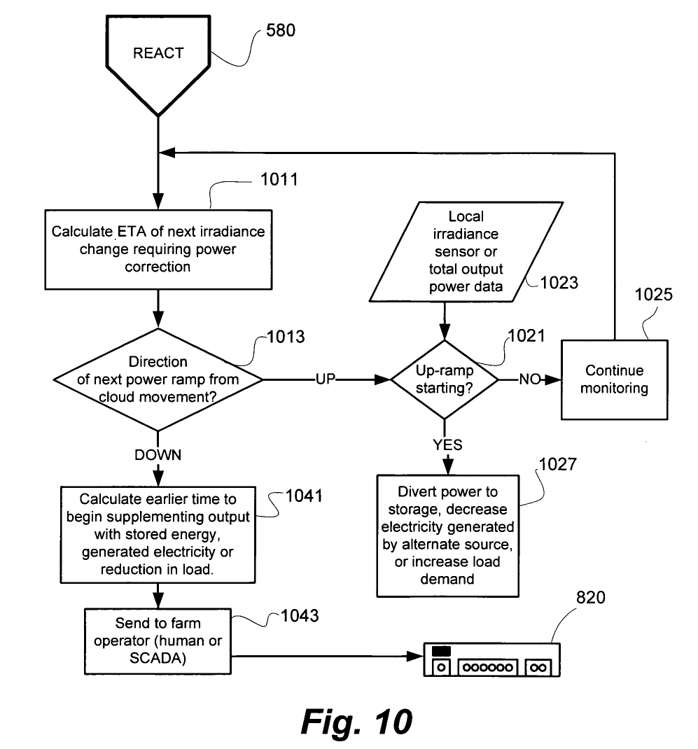

FIG. 10 is a flow diagram depicting reaction steps for energy storage, which is similar to the reaction steps for ramp-rate control depicted in FIG. 9. A calculation (step 1011) is made for the estimated time of arrival of the next irradiance change requiring power correction. From calculation 1011, a determination (step 1013) is made of the direction of the next power ramp from cloud movement. In the case of an up power ramp determination (at determination step 1013), a determination 1021 of up ramp starting is made based on receipt of local irradiance sensor data, or (step 1023). The measured power output (step 1023) can be the total power output of the farm, a portion of the total output, or may be from one or more sensors. The determination is continued (step 1025) until an increase in local sensor data, in which power is diverted or suppressed (step 1027) to slow down the up-ramping. In the case of available storage capacity, the slowing down (step 1027) of up-ramping is achieved by diverting power to storage.

In the case of a down power ramp determination (at determination step 1013), a calculation (step 1041) is made of an earlier time to begin a gradual ramp-down. The calculation is sent (step 1043) to the farm operator. The farm operator may be human, or alternatively, the farm operator may be SCADA module 820 or other computerized system.

Sensing and Responding to Changed Power Output Conditions

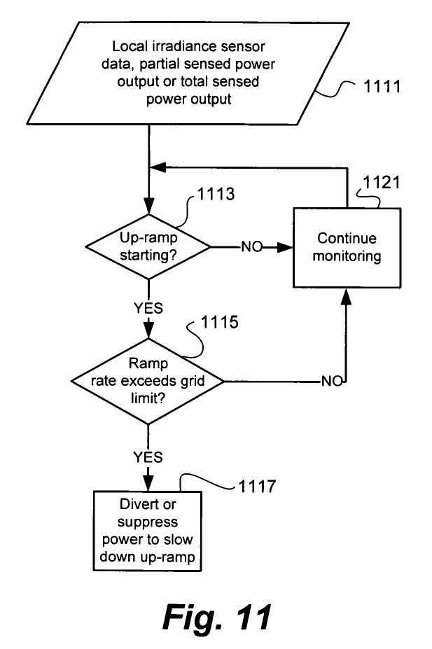

FIG. 11 is a flow diagram depicting a configuration in which sensed power is used to control ramp rate. In the example configuration, an up-ramp of power is detected. Local irradiance data, partial power output or total power output is sensed (step 1111). A determination (step 1113) is made whether an up-ramp event is occurring, and if an up-ramp event is sensed, a determination (step 1115) is made as to whether the up-ramp event exceeds a grid limit which may be predetermined or may include a variable tolerance factor provided by the utility. If the up-ramp event is sensed and exceeds the grid limit, then the power output is either suppressed or diverted sufficiently to maintain the rate of power increase 1117 within limits as applied to determination 1115.

In the event that the up-ramp is not detected (step 1113) or the up-ramp does not exceed the grid limit, the system continues to monitor power output (step 1121).

### CONCLUSION

Using these techniques, power stations can dynamically respond to weather-related effects that change their output power, thus maintaining the desired stability of power to the grids they supply. With this capability, clean and renewable, but inherently intermittent and weather-sensitive, power sources such as solar and wind farms can mitigate the power output fluctuations that currently make them incompatible with smaller or less-flexible existing power grids. These techniques also enable such sources to sell scheduled power as well as the intermittent energy they normally provide. Further, with these predictive techniques, energy from intermittent and non-intermittent sources could be supplied to a grid through the same interconnection point.

The techniques and modules described herein may be implemented by various means. For example, these techniques may be implemented in hardware, software, or a combination thereof. For a hardware implementation, the processing units within an access point or an access terminal may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques described herein may be implemented with modules (e.g., procedures, functions, and so on) that perform the functions described herein. The software codes may be stored in digital storage media, memory units and executed by processors or demodulators. The memory unit may be implemented within the processor or external to the processor, in which case it can be communicatively coupled to the processor via various means.

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of controlling a power generation system having a power output affected by weather-related factors, the method comprising:
obtaining information about changes in weather-related factors capable of affecting the power output;
calculating one or more of an amplitude, a rate of change, an onset, and a duration of an expected power-output change resulting from the changes in weather-related factors described in the obtained information;
comparing the expected power-output change with predetermined threshold criteria to produce a comparison result; and
selecting and executing a response corresponding to the comparison result.

2. The method of claim 1, where the obtaining of information comprises at least one of:
receiving measurement data from weather sensors located at or near the power generation system,
monitoring data from external sources of weather-related information, and
accessing historical weather-related data for the power generating system's location.

3. The method of claim 2, where the changes in weather-related factors comprise changes in at least one of:
cloud coverage,
cloud type,
cloud position,
cloud movement,
cloud density,
cloud transmission of various spectral components of sunlight,
cloud scattering of sunlight,
wind speed,
wind shear,
wind direction,
environmental lapse rate,
atmospheric pressure gradients, and
atmospheric temperature gradients.

4. The method of claim 1, further comprising inferring changes in weather factors from identifiable characteristics of changes in a localized weather-sensitive power source's power output.

5. The method of claim 1, further comprising:
retrieving stored information on solar position and angle relative to a solar panel in the power generation system for the time of the expected power-output change, and
analyzing the effect of the change in weather-related factors on solar irradiance on the solar panel during the time of the expected power-output change.

6. The method of claim 1, further comprising:
measuring actual power-output changes from the power-generating system at times substantially corresponding to the onset and duration of the expected power-output changes,
storing the measurements of actual power output in an archive along with the corresponding obtained information and calculated effects on power output,
searching the archive for stored records having substantially similar obtained information to the information presently obtained,
comparing the stored records' expected power-output changes to the corresponding actual power-output changes,
calculating correction factors from discrepancies between the expected and actual power-output changes in the stored records, and
applying the correction factors to the expected power-output changes calculated for the information presently obtained.

7. The method of claim 1, where the predetermined threshold criteria comprise at least one of:
acceptable power-output ranges from the power generation system, and
acceptable power-output ramping rates from the power generation system.

8. The method of claim 7, where the predetermined threshold criteria are based on at least one of:
customer specifications,
regulatory requirements,
power connectivity standards,
demand schedules,
limitations of a connected grid, and
production targets of scheduled power & intermittent energy.

9. The method of claim 1, where:
the comparison result comprises a weather-related decrease in output power at a rate exceeding the predetermined threshold, and
the corresponding response comprises gradually decreasing the power delivered by the power generating system, beginning in advance of the expected onset of the weather-related decrease, at a rate that does not exceed the predetermined threshold.

10. The method of claim 9, where gradually decreasing the power delivered comprises at least one of:
ceasing power delivery from a selected inverter at a selected time,
resuming power delivery from a selected inverter at a selected time, and
changing the operating point of a selected inverter at a selected time.

11. The method of claim 9, further comprising diverting to an energy storage device any generated power that would otherwise be discarded in the course of gradually decreasing the power delivered.

12. The method of claim 1, where:
the comparison result comprises a weather-related increase in output power at a rate exceeding the predetermined threshold, and
the corresponding response comprises slowing the increase in power delivered by the power generating system, beginning when the weather-related increase is sensed, at a rate that does not exceed the predetermined threshold.

13. The method of claim 12, where slowing the increase in power delivered by the power generating system comprises at least one of:
ceasing power delivery from a selected inverter at a selected time,
resuming power delivery from a selected inverter at a selected time,
changing the operating point of a selected inverter at a selected time, and
using an inverter that automatically senses an increase in input power and responds by limiting the upward rate of change in output power.

14. The method of claim 12, further comprising diverting to an energy storage device any generated power that would otherwise be discarded in the course of slowing the increase in power delivered.

15. A machine-readable storage medium programmed with instructions and data for operating a power generation system having a power output affected by weather-related factors, the instructions and data comprising:
location data for a weather-sensitive power source,
instructions for obtaining information about changes in weather-related factors capable of affecting the power output of the weather-sensitive power source;
instructions for calculating an amplitude, rate of change, onset, and duration of an expected power-output change resulting from the changes in weather-related factors described in the obtained information;
instructions for comparing the expected power-output change with predetermined threshold criteria to produce a comparison result;
data on a plurality of recommended system responses to comparison results, and
instructions for selecting and executing a response corresponding to the comparison result.

16. The storage medium of claim 15, where the instructions for obtaining information comprise at least one of:
location data for sensors linked to the power generation system and instructions for receiving measurements from the sensors;
location data related to external sources of weather-related information and instructions for monitoring data from the external sources; and
historical weather-related data for the power generating system's location.

17. The storage medium of claim 16, where the instructions for calculating an expected output change comprise formulae for calculating the effect on output power of at least one of:
cloud coverage,
cloud type,
cloud position,
cloud movement,
cloud density,
cloud transmission of various spectral components of sunlight,
cloud scattering of sunlight,
wind speed,
wind shear,
wind direction,
environmental lapse rate,
atmospheric pressure gradients, and
atmospheric temperature gradients.

18. The storage medium of claim 15, further comprising:
location data for an additional weather-sensitive power source,
instructions for monitoring local power output from the weather-sensitive power source and the additional weather-sensitive power source, and
instructions for inferring changes in weather factors from identifiable
characteristics of the monitored local power outputs.

19. The storage medium of claim 15, further comprising:
time-dependent solar position and angle data relative to a solar panel in the power generation system, and
instructions for including the solar position and angle data in an analysis of expected changes in solar irradiance on the solar panel during the calculated onset and duration times.

20. The storage medium of claim 15, further comprising:
instructions for measuring actual changes in output power from the power-generating system and writing the measurements to an archive along with the corresponding obtained information and the calculated effects on power output,
instructions for searching the archive for stored records having substantially similar obtained information to the information presently obtained,
instructions for comparing the stored records' expected power-output changes to the corresponding actual power-output changes,
instructions for calculating correction factors from discrepancies between the expected and actual power-output changes in the stored records, and
instructions for applying the correction factors to the expected power-output changes calculated for the information presently obtained.

21. The storage medium of claim 15, where the predetermined threshold criteria comprise at least one of:
acceptable power-output ranges from the power generation system, and
acceptable power-output ramping rates from the power generation system.

22. The storage medium of claim 21, where the predetermined threshold criteria are based on at least one of:
regulatory requirements,
demand schedules,
limitations of a connected grid, and
production targets of scheduled power & intermittent energy.

23. The storage medium of claim 15, where: the response corresponding to an expected weather-related decrease in output power at a rate exceeding the predetermined threshold comprises gradually decreasing the power delivered by the power generating system, beginning in advance of the expected onset of the weather-related decrease, at a rate that does not exceed the predetermined threshold.

24. The storage medium of claim 15, where the response corresponding to an expected weather-related increase in output power at a rate exceeding the predetermined threshold comprises slowing the increase in power delivered by the power generating system, beginning when the weather-related increase is sensed, at a rate that does not exceed the predetermined threshold.

25. The storage medium of claim 15, further comprising instructions for controlling at least one selected inverter in the power generating system at selected times to do at least one of:
temporarily ceasing power delivery,
resuming power delivery,
changing its operating point, and
limiting its rate of power-output increase when it senses a power-input increase.

26. The storage medium of claim 15, further comprising instructions for diverting to an energy storage device any generated power that would otherwise be discarded in the course of gradually decreasing or slowing the increase of the power delivered.

27. Means for controlling a power generation system having a power output affected by weather-related factors, the method comprising:
means for obtaining information about changes in weather-related factors capable of affecting the power output;
means for calculating an amplitude, rate of change, onset, and duration of an expected power-output change resulting from the changes in weather-related factors described in the obtained information;
means for comparing the expected power-output change with predetermined threshold criteria to produce a comparison result; and
means for selecting and executing a response corresponding to the comparison result.

28. The means as described in claim 27, where the means for obtaining information obtains the information from at least one of:
sensors linked to the power generation system,
weather sensors located at or near the power generation system,
external sources of real-time weather-related information, and
histories of past weather-related data for the power generating system's location.

29. The means as described in claim 27, where the means for obtaining information provides real-time quantitative data on at least one of:
cloud coverage,
cloud type,
cloud position,
cloud movement,
cloud density,
cloud transmission of various spectral components of sunlight,
cloud scattering of sunlight,
wind speed,
wind shear,
wind direction,
environmental lapse rate,
atmospheric pressure gradients, and
atmospheric temperature gradients.

30. The means as described in claim 27, further comprising:
means for calculating solar position and angle relative to a solar panel in the power generation system for the calculated onset and duration times, and
means for analyzing the change in solar irradiance on the solar panel during the calculated onset and duration times due to the weather-related factor changes in the obtained information.

31. The means as described in claim 27, further comprising
means for applying correction factors to a presently calculated amplitude, rate of change, onset, and duration of an expected power-output change, the correction factors based on past discrepancies between actual power-output changes and calculated power-output changes corresponding to weather-related factor changes similar to those indicated in the presently obtained information.
